(19) United States
(12) Patent Application Publication
(10) Pub. No.: US 2021/0117907 A1
(43) Pub. Date: Apr. 22, 2021

(54) SCRUM PROGRAM BOARD SYSTEMS AND METHODS

(71) Applicant: ServiceNow, Inc., Santa Clara, CA (US)

(72) Inventors: Thomas William Gray, Acworth, GA (US); Anna Kotliarevskaia, San Diego, CA (US); Madhu Geddam Umapathy, Santa Clara, CA (US)

(21) Appl. No.: 16/656,274

(22) Filed: Oct. 17, 2019

(51) Int. Cl. G06Q 10/06; G06F 8/70; G06F 16/904

(52) U.S. Cl. CPC G06Q 10/063118; G06F 16/904; G06F 8/70; G06Q 10/063114

(57) ABSTRACT

Present embodiments include systems and methods for generating a visualization presenting a list of tasks associated with a project as assigned to various teams in their respective sprints. The visualization may include dependencies between tasks, team bandwidth, status indicators, among other features, to enhance project planning. As mentioned above, systems and methods include generating the visualization based on team information, such as tasks and a timeframe, such as a sprint, for completing the tasks, as well as dependencies between the tasks. Present embodiments include presenting the visualization, such that respective sprints between certain teams may be independent from one another and start and end at respective start times and end times. As a result, teams may have the flexibility to operate according to their own timeframe because the start and end of one team's sprints may be independent and untethered to the start and end of another team's sprints.

### BACKGROUND

The present disclosure relates generally to systems and methods for creating and updating development plans.

This section is intended to introduce the reader to various aspects of art that may be related to aspects of the present disclosure, which are described and/or claimed below. This discussion is believed to be helpful in providing the reader with background information to facilitate a better understanding of aspects of the present disclosure. Accordingly, it should be understood that these statements are to be read in this light, and not as admissions of prior art.

Developing project plans in a computing environment may be a complex process. To manage this complexity, a number of project planning models and tools have been developed. For example, in various industries, complex projects may be broken down into specific tasks, which themselves may be broken into sub-tasks, each with a respective completion deadline to facilitate completion of the complex projects according to a timeline. Each project may include several tasks, and different projects may have corresponding teams of personnel (e.g., workers) assigned to various roles in the project. These tasks may be prioritized according to various metrics, such as difficulty, urgency, dependency of other tasks on a given task, and the like.

In some industries, the teams of personnel may vary in size, such that larger teams with more personnel are able to complete tasks at a quicker rate than a smaller team with less personnel. Even in teams of the same or similar size, the different teams may be accustomed to scheduling blocks or intervals of different sizes, such as one team may have work scheduled in two week blocks, while another team may manage work based on three week blocks. However, existing approaches may fail to account for the complexities associated with differences in teams, especially when there exist dependencies between teams (e.g., a first task assigned to a first team is to be completed before a second tasks assigned to a second team), and therefore may lack a structured approach for coordinating timing data between teams, projects, or both. Accordingly, present approaches may benefit from improvements regarding developing and structuring various plans and projects, while taking into account various factors to enhance the planning and efficient completion of the plans and projects.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Present embodiments include systems and methods for generating a scrum program visualization, on a graphical user interface (GUI), presenting a list of tasks associated with a project as assigned to various teams in their respective sprints. The scrum program visualization may include dependencies between tasks, team bandwidth, status indicators, among other features, to enhance project planning. As mentioned above, systems and methods include generating the scrum program visualization based on team information, such as tasks and a timeframe, such as a sprint, for completing the tasks, as well as dependencies between the tasks. To that end, present embodiments include presenting the scrum program visualization, such that the start time and end time for sprints between certain teams may be independent from one another. As a result, teams may have the flexibility to operate according to their respective, independent timeframe because the start and end of one team's sprints may be independent and untethered to the start and end of another team's sprints. In this manner, project management may be improved by allowing teams to operate on their respective sprints, while allowing teams to identify dependencies between tasks to ensure prompt completion of an overall project. By improving the techniques used to plan projects and tasks, teams of varying sizes and resources may operate on their own schedules, an enterprise may increase its efficiency, and projects may be completed in a timelier manner.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system, in accordance with aspects of the present disclosure;

FIG. 2 is a block diagram of a computing device utilized in a computing system that may be present in FIG. 1, in accordance with aspects of the present disclosure;

FIG. 3 is a flow diagram of a process for generating a scrum program visualization presenting tasks on a timeline, in accordance with aspects of the present disclosure;

FIG. 4 is a screenshot of the scrum program visualization generated on a graphical user interface by employing the process of FIG. 3, in accordance with aspects of the present disclosure;

FIG. 5 is a screenshot of the scrum program visualization of FIG. 4, including tasks assigned to teams, in accordance with aspects of the present disclosure;

FIG. 6 is a screenshot of the scrum program visualization of FIG. 4, including dependency indications between the tasks of FIG. 5, in accordance with aspects of the present disclosure;

FIG. 7 is a screenshot of the scrum program visualization of FIG. 4, including team bandwidth for the sprints of the teams of FIG. 5, in accordance with aspects of the present disclosure;

FIG. 8 is a screenshot of the scrum program visualization of FIG. 4 including a selectable icon for creating a new task and a drop down menu for selecting additional projects to view, in accordance with aspects of the present disclosure;

FIG. 9 is a screenshot of the scrum program visualization of FIG. 4, including additional tasks assigned to the teams of FIG. 5 in the sprints of FIG. 7, in accordance with aspects of the present disclosure; and

FIG. 10 is a screenshot of the visualization of FIG. 4, including a marker indicative of the current date, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device that includes processing circuitry, such as, but not limited to, a single computer, virtual machine, virtual container, host, server, laptop, mobile device, or to a plurality of electronic computing or processing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “an agile methodology,” or agile development methodology or agile development framework, may refer to a project development methodology characterized by a short, fixed schedule of cycles, called “sprints”, performed in a development process. In contexts employing the agile or other development methodologies, a “sprint” may refer to any period of time, such as a few weeks or so, during which a team of software developers will complete a software feature. As used herein, “a story” may refer to the tasks competed and executed using the agile methodology. A story may correspond to execution tasks or work items needed to complete a given feature. In some implementations, the story may refer to a completed software aspect from a backlog of software features desired to be included in the application. As used herein, a “feature” may refer to a strategy layer including functionality that delivers valuable content to target enterprises and may be comprised of a plurality of stories. In either case, to facilitate discussion, features and stories are more generically referred to below as “tasks.” As used herein, “scrum” may refer to a particular implementation of agile methodologies, in which incremental outputs of completed tasks are periodically (e.g., every two weeks, every three weeks, and so forth) delivered to a customer. In some contexts, scrum may be used in projects having rapidly changing tasks because it may provide users with the flexibility to quickly react to changes.

As used herein, “project” may refer to a large undertaking to complete a milestone and may be broken down into smaller individual “tasks.” As used herein, “task” may refer to a smaller undertaking, such as features and stories, associated with a project and aimed at completion of the project. To that end, a project may include many tasks. For example, a project may include developing a software application for public use by January 2021. The project may include a first task, such as creating a graphical user interface (GUI) prototype by March 2020; a second task, such as testing the GUI with users by April 2020; and any other subsequent task aimed at working toward completion of the overall project (e.g., developing the software application for public use).

Indeed, certain enterprises may employ an agile methodology to facilitate project and task planning by prioritizing and sequencing different tasks of a project, such as projects for developing an application, addressing defects or problems, and any other suitable projects that may be split up into smaller tasks. However, certain existing approaches may require that all teams be organized using sprints of similar duration (i.e., having the same start date and the same completion date), which may be impractical for certain teams, such as where teams have different sizes, different scheduling start and end dates, and/or use scheduling blocks of different sizes (e.g., two weeks versus three weeks). For example, a first team may have more people and resources than a second team, such that the first team may complete their tasks at a faster pace than the second team. In this case, overall enterprise efficiency may improve if the first team could operate on a schedule having a duration not tied to the schedule of the second team. That is, overall efficiency may increase if the first team operated in a sprint having a shorter duration than the sprints under which the second team operates. Accordingly, these existing approaches may benefit from improvements by allowing teams to complete tasks according to their respective sprint cycles, supporting their unique, respective schedules, while taking into account timing requirements, differences between teams, associations between teams and projects, and a desire for a user friendly interface, the implementation and coordination of which may be difficult to implement in practice.

With this in mind, present embodiments include systems and methods for improving project and task planning by providing multiple teams of users (e.g., workers) scheduling flexibility by allowing the teams to work in sprints that vary in duration as compared to the sprints in which other teams may work. That is, certain existing approaches may require that all sprints to begin at the same date (e.g., the first Monday of a month) and end at a shared deadline (e.g., the last Friday of the month). In a less restricting manner, present embodiments provide more flexibility to organizations in that a team may operate in a sprint that is different in terms of start date, end date, and/or duration than the sprints of other teams. For example, a first team may wish to operate under a sprint starting the first Monday of a month and ending on the last Friday of the month, while a second team may wish to operate under sprints that have a two-week duration. Present embodiments include causing a computing system to present a timeline of teams and their corresponding sprints, as well as dependencies between the sprints to ensure that a preceding task is completed when the output of the preceding tasks may be used as an input for subsequent tasks. In this manner, project management may be improved by allowing teams to operate on their respective, independent sprints (starting and ending at times independent of the start and end times of sprints of other teams), while generating and presenting dependencies between tasks to facilitate prompt completion of an overall project.

By improving the techniques used to plan projects and tasks, teams of varying sizes and resources may operate on their own schedules, an enterprise may increase its efficiency, and projects may be completed in a timelier manner.

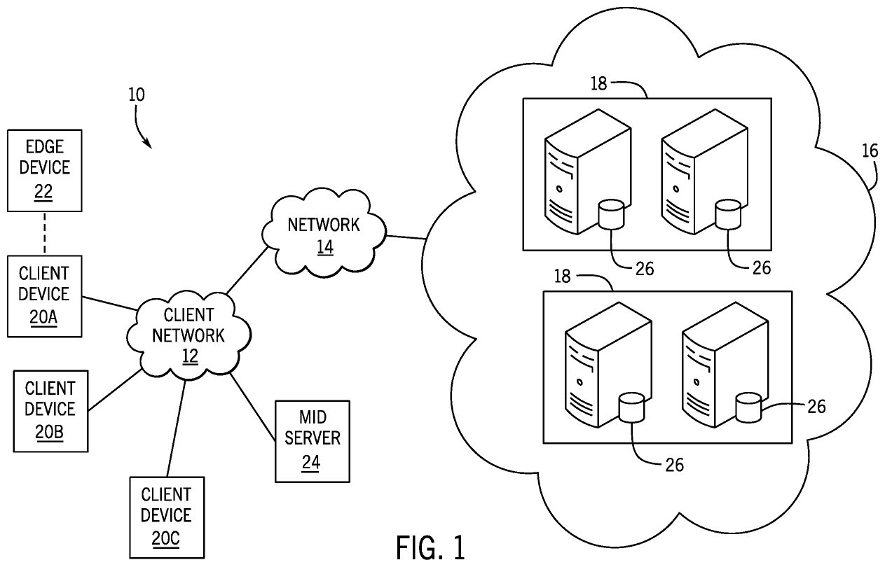

With the preceding in mind, the following figures relate to various types of generalized system architectures or configurations that may be employed to provide services to an organization in a multi-instance framework and on which aspects of the present disclosure may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 may be configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules.

As may be appreciated, the respective architectures and frameworks discussed with respect to FIG. 1 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion. For example, a computing system having access to the network 14 may be able to access and customize certain resource allocation data based on an identity of the entity (e.g., user) associated with the computing system and/or based on the layer of the multi-layer resource allocation hierarchy to which the user is assigned.

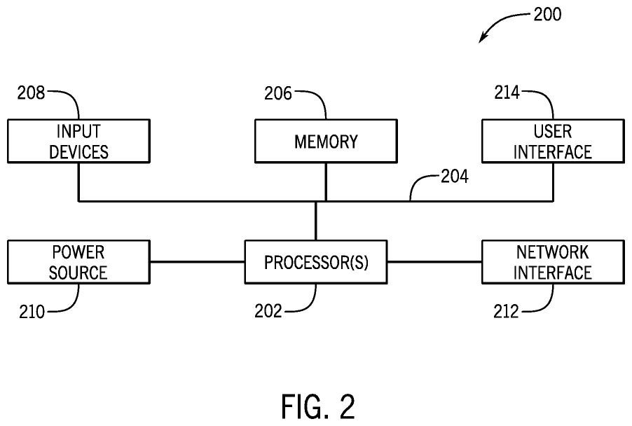

By way of background, it may be appreciated that the present approach may be implemented using one or more processor-based systems such as that shown in FIG. 2. Likewise, applications and/or databases utilized in the present approach may be stored, employed, and/or maintained on such processor-based systems. As may be appreciated, such systems as shown in FIG. 2 may be present in a distributed computing environment, a networked environment, or other multi-computer platform or architecture. Likewise, systems such as that shown in FIG. 2, may be used in supporting or communicating with one or more virtual environments or computational instances on which the present approach may be implemented.

An example computer system may include some or all of the computer components depicted in FIG. 2 and facilitate implementing the techniques disclosed herein. FIG. 2 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

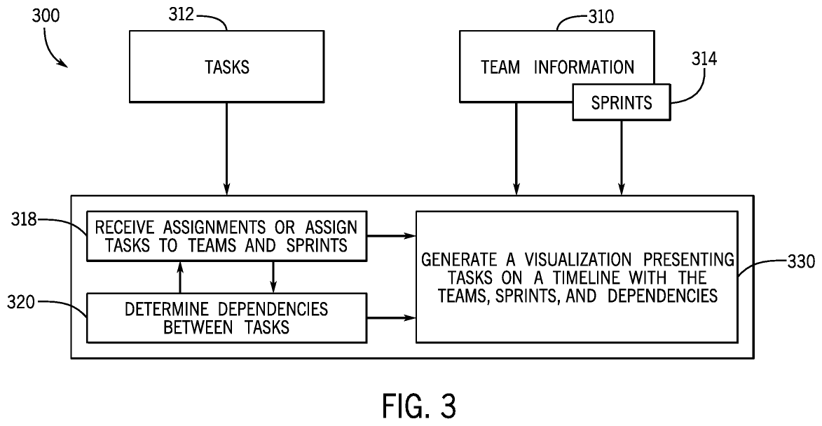

With the preceding in mind, FIG. 3 is a flow diagram of a process 300 for generating a scrum program visualization, such as on a GUI, presenting tasks on a timeline, in accordance with aspects of the present disclosure. In some contexts, the steps of the process 300 may be stored as executable code in one or more non-transitory mediums (e.g., memory or other storage of a data server storing instructions and/or the memory 206 of FIG. 2). The instructions may be executed by one or more hardware processors (e.g., of an application server and/or the one or more processors 202 of FIG. 2), such that the one or more hardware processors may execute the code to perform the process 300.

As illustrated, the process 300 includes receiving team information 310 associated with teams. In some contexts, the team information 310 may be stored on memory or other storage of a data server storing instructions and/or the memory 206 of FIG. 2. As discussed above, a team may be assigned a variety of tasks for completion, such that the tasks are part of a larger project. The process 300 may also include receiving tasks 312 for completion. In the illustrated example, the process 300 includes receiving (process block 318) assignments of tasks 312 to certain teams and/or sprints, and/or assigning (process block 318) tasks to teams and/or sprints 314. In some contexts, users having an authority to assign tasks to teams may assign tasks to suitable teams. In such contexts, the computing system 10 may receive this assignment. In this manner, an authorized user may oversee the assignment of tasks 312 to teams and/or sprints 314.

Alternatively or in addition, the computing system 10 may assign (process block 318) tasks to teams and sprints 314 based on team information 310. For example, the computing system 10 may assign a team having has the bandwidth and flexibility to complete a task 312 in a respective sprint 314. In this manner, the process of assigning tasks 312 to teams and sprints 314 may be performed by the computing system 10 based on any suitable team information 310. In either case, after the tasks 312 have been assigned to teams and sprints 312, the team information 310 may update to include the assigned tasks 312 and to which sprint(s) 314 the tasks have been assigned.

The team information 310 may include the sprints 314 defining a duration for completion of the tasks 312. For example, a first team may be assigned a corresponding first task, second task, and third task, each to be completed in accordance with a sprint (e.g., a two week sprint). Continuing this example, a second team may be assigned a corresponding first task, second task, and third task, each to be completed in accordance with another sprint (e.g., a three week sprint). Meanwhile, a third team may be assigned a corresponding first task, second task, and third task, each with different sprints (e.g., a one week sprint, a two week sprint, and a three week sprint, respectively). Accordingly, the first team, the second team, and the third team may operate on their own schedules by way of sprints that begin and end at different times and/or of different durations in accordance with team preferences, thereby providing teams with project planning flexibility. Additionally, the team information may include the list of workers assigned to the tasks, subtasks (e.g., stories) and the corresponding workers and timeline for completion, among other data.

In the illustrated example, the process 300 also includes determining (process block 320) dependencies between teams. In some contexts, the agile methodology may organize the tasks for any one given project, such that certain tasks are planned to be completed before other tasks. To that end, determining (process block 320) dependencies between teams may include determining dependencies between tasks, even though the dependencies between the tasks may span multiple teams. For example, the second task assigned to the second team may be planned to occur before the first task assigned to the third team for any number of reasons (e.g., the output of the second task of the second team, say, the creation of a GUI, may be an input to the first task of the third team, say, implement client testing of the GUI). As such, determining (process block 320) dependencies between teams may be based on the received (process block 310) team information.

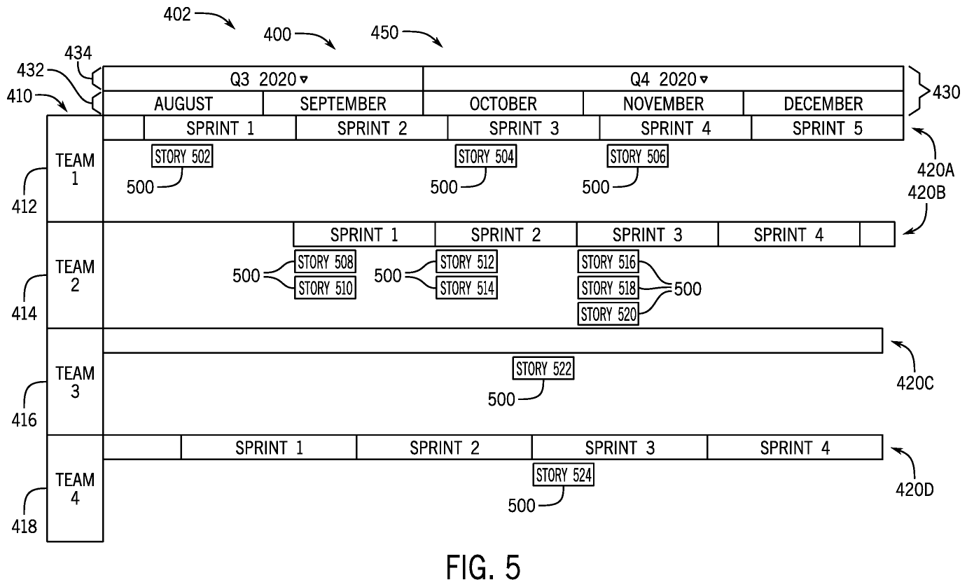

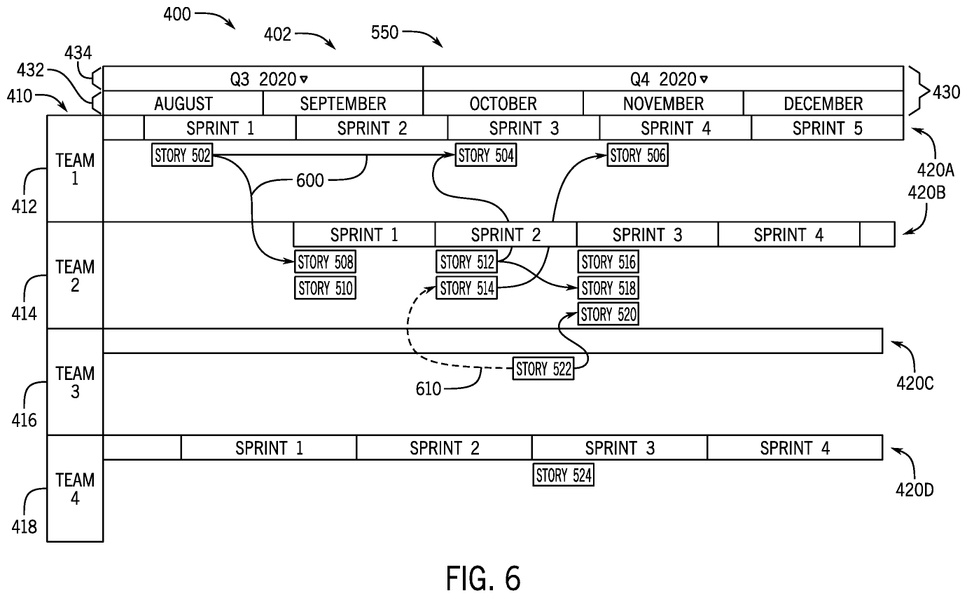

Furthermore, as illustrated in this example, the process 300 includes generating a scrum program visualization presenting the tasks on a timeline with the determined (process block 320) dependencies. The dependencies may be presented on the scrum program visualization as any suitable indication, such as an arrow. The scrum program visualization may present the teams on one axis and the timeline on another perpendicular axis, such that the tasks are positioned on the visualization based on the team information, as illustrated in FIG. 5. Additionally, a dependency indication may be presented between two tasks that depend on one another as illustrated in FIG. 6.

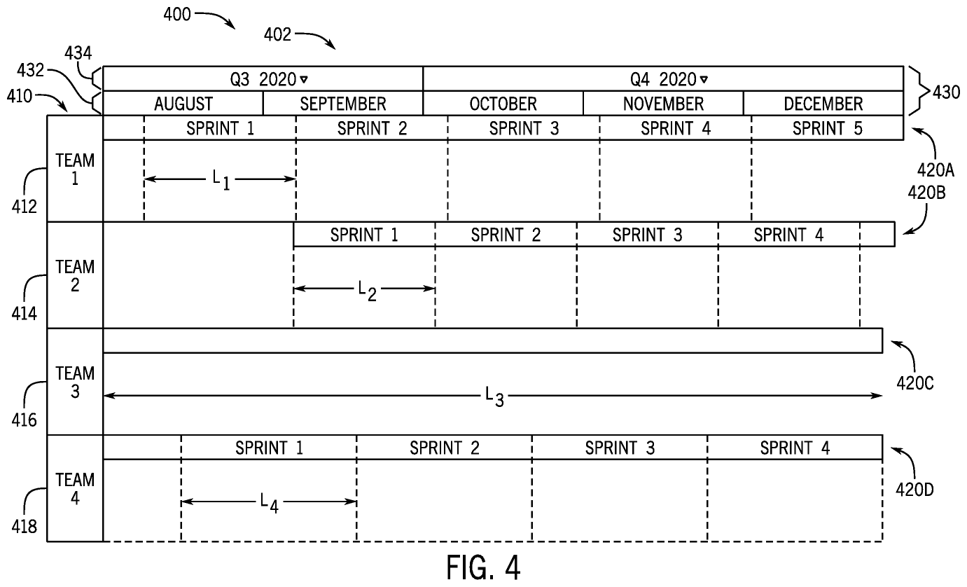

FIG. 4 is a screenshot of the scrum program visualization 400 generated on the GUI 402 by employing the process 300 of FIG. 3, in accordance with aspects of the present disclosure. The computing system 10 (FIG. 1) may generate the visualization 400 and the GUI 402 based on the team information, as discussed above. In the illustrated example, the visualization 400 includes teams 410; namely a first team 412, a second team 414, a third team 416, and a fourth team 418; organized with corresponding sprints 420 along a timeline 430. The timeline 430 may include month information 432 or quarterly information 434. In this manner, a user may view information about the sprints 420 for the teams 410 with respect to yearly quarters or months of the year. It should be appreciated that the timeline 430 may include additional information, such as days, weeks, years, and so forth.

The sprints 420 may vary in duration between the teams 410. To help illustrate and as an example, the sprints 420A for the first team 412 may be of a duration L1, such as three weeks. The sprints 420B for the second team 414 may be of a duration L2, such as two weeks or a duration shorter than L1. The sprints 420C for the third team 416 may be of no pre-defined length, such that sprints 420 of any particular duration, L3, may be assigned to the third team 416, for example, on an as-needed-basis. The sprints 420D for the fourth team 418 may be of a duration of L4, such as three weeks. The team information used by the computing system 10 to generate the visualization 400 may include the sprints 420, the durations of the sprints 420, and their corresponding start and finish times as they relate to the timeline 430.

As illustrated, the sprints 420 for each of the teams 410 may start at respective times, such that the teams 410 may operate at respective and different sprints 420. For example, the first sprint (i.e., “Sprint 1”) of the first team 412 may start in early August 2020 and the first sprint (i.e., “Sprint 1”) of the fourth team 418 may start at another time, such as in mid-August 2020. In this manner, while the sprints 420 of certain teams may be of a similar duration, such as that of the sprints 420A of the first team 412 and the sprints 420D of the fourth team 418 (e.g., having a duration of L1 and L4, namely, three weeks, respectively), the sprints 420 between these teams may operate independently between these teams. For example, the start time and finish time of a sprint for one team may operate independently of the start time and finish time of a sprint for another team. In this manner, teams may have more flexibility in their manner of operating because the teams 410 may operate in sprints 420 that start independently of other teams 410.

Present embodiments allow further flexibility by allowing certain teams 410, such as the third team 416, to create sprints 420 on an as-needed-basis. For example, while the first, second, and fourth teams 412, 414, 418 includes periodically repeating sprints 420, the sprints 420C of the third team 416 may be generated at any time having a duration, L3, of any length. A user having authority to do so (e.g., a user satisfying a certain criteria) may access the scrum programs visualization 400, hover over the timeline corresponding to the third team 416, and make a selection to generate a new sprint. The authorized user may select a start time, an end time, or a duration for the newly created sprint.

FIG. 5 is a screenshot 450 of the scrum programs visualization 400 of FIG. 4, including tasks 500 assigned to teams 410, in accordance with aspects of the present disclosure. As illustrated, the teams 410 may include tasks 500 organized into respect sprints 420. The first sprint 420A of the first team 412 may include a first task 502, in this example, “story 502;” the third sprint 420A of the first team 412 may include a second task 504, in this example, “story 504;” and the fourth sprint 420A may include a third task, in this example, “story 506.” In the illustrated example, the second team 414 is assigned seven tasks 508, 510, 514, 516, 518, and 520; the third team 416 is assigned one task 522; and the fourth team is assigned one task 524.

In some contexts, certain sprints 420 may be assigned more than one task 500. As illustrated, the second sprint 420B (i.e., Sprint 2) of the second team 414 may be assigned two tasks 500, in this example “story 512” and “story 514.” The computing system 10 (FIG. 1) may receive team information, such as the tasks assigned to each sprint, to generate the visualization 400.

As discussed above, while these tasks 500 may be organized in accordance with respective sprints 420 of the teams 410, such that the tasks 500 are to be completed during their assigned sprint 420, it may be appreciated that the tasks 500 operate in independent schedules between teams 410. That is, the start date and deadline date of the sprints 420A of the first team 412 do not influence the start date and deadline date of the sprints 420B, 420C, 420D of the second, third, and fourth teams 414, 416, 418. Therefore, the teams 410 may operate at sprints best suited for that team's number of workers, resources, and so forth.

FIG. 6 is a screenshot 550 of the scrum program visualization 400 of FIG. 4, including dependency indications 600 between tasks 500 on the GUI 402, in accordance with aspects of the present disclosure. The computing system 10 may generate the dependencies indications 600 between the tasks 500 based on team data, such as tasks to be completed before work can begin on a particular task. In this example, the task 504 of the first team 412 is dependent upon the task 502 of the first team 412 and task 512 of the second team 414. This dependency may exist because the output of one task 500 may be the input for another task. Continuing this example, the task 502 may include building a navigation panel for a program and the task 504 may include testing the navigation panel on various operating systems, such that the navigation panel must be built before any testing may occur. Therefore, the task 504 may be dependent upon the completion of task 502, and the computing system may receive information indicative of such dependency to generate the dependency indication 600.

In some contexts, the dependency indications 600 may be generated as dependency visualizations, such as arrows, lines, links, and so forth. In the illustrated example, the dependency indications 600 are illustrated as arrows where the arrow points in the direction of the dependency. For example, the arrow pointing from the task 502 toward the task 504 may indicate that the task 504 is dependent on the task 502.

The computing system 10 (FIG. 1) may flag certain dependency indications, such as the illustrated flagged dependency 610. The computing system 10 may flag those dependencies 610 which are chronologically out of order. For example, there may exist a dependency between the task 522 and the task 514, such that the third team is to complete the task 522 before the task 514. However, as illustrated, the task 522 is set to start after the completion of the task 514. The computing system 10 may determine that the task 514 depends on the completion of the task 522, but the task 522 is organized to start after the completion date for the story 514. Based on this determination, the computing system 10 may flag the dependency 610. In certain contexts, the flagged dependencies 610 may be distinguished from the normal dependencies 600. While in the illustrated example, the flagged dependencies 610 are dashed lines instead of solid lines, it may be appreciated that in certain contexts the flagged dependency 610 may be distinguished by a different color (e.g., red) or a thicker arrow than the normal dependencies 600. Furthermore, the computing system 10 may omit the flagged dependency 610 in response to determining that the dependencies are in a suitable chronological order.

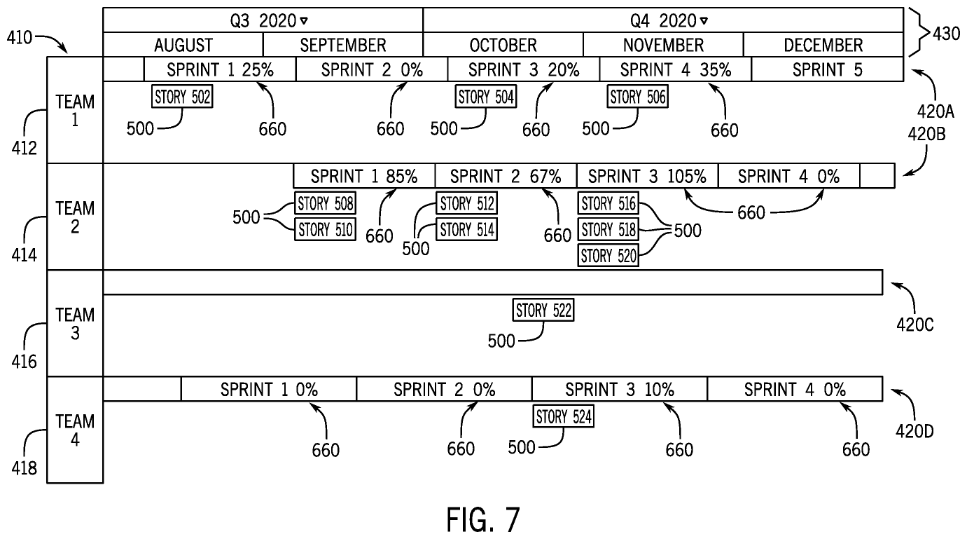

FIG. 7 is a screenshot 650 of the scrum program visualization 400 of FIG. 4 on the GUI 402 of FIG. 4, including team bandwidth 660 for each of the sprints 420, in accordance with aspects of the present disclosure. As used herein, “bandwidth” refers to the capacity of a team 410 to take on more work (e.g., tasks 500). For example, a team 410 having a bandwidth 660 of 90% indicates that the team 410 is 10% away from being at maximum capacity with regard to the amount of work that the team 410 may produce. To that end, a team 410 having a bandwidth 660 of 80%, for example, will likely be busier and may be unable to accomplish another task as compared to another team 410 with a bandwidth of 25%. In some contexts, the computing system 10 (FIG. 1) may provide the bandwidth for each team 410 at corresponding sprints 420. As such, an indication of a team's bandwidth 660 may facilitate project management and assignment by providing an indication of which teams 410 are able to take on additional tasks 500.

As illustrated, the computing system 10 may generate the visualization 400, such that each sprint 420 includes a corresponding bandwidth 660 listed as a percentage of capacity, as discussed above. The bandwidth 660 may instead or in addition be represented as a fraction showing how many tasks the team has been assigned for any given sprint over the total number of tasks the team has the capacity for. Additionally, the bandwidth 660 may update over time, for example, as teams 410 get assigned tasks 500 or as the schedule for members of the team changes (e.g., as members take vacation). The computing system 10 may receive (process block 310 of FIG. 3) this information as the team information.

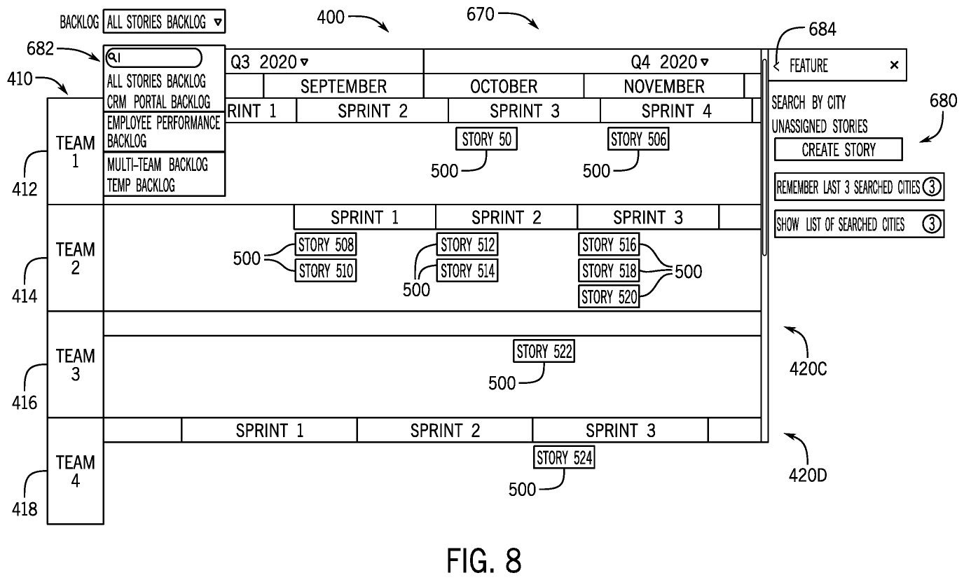

FIG. 8 is a screenshot 670 of the scrum program visualization 400 of FIG. 4 generated on the GUI 402 of FIG. 4, including a selectable icon 680 for creating a new task 500 and a drop down menu 682 for selecting additional projects to view, in accordance with aspects of the present disclosure. The computing system 10 (FIG. 1) may present the selectable icon 680 in response to selection of an expanding arrow 684, which causes the computing system 10 to expand a small window that includes the selectable icon 680. The selectable icon 680 includes options for creating a new task 500, assigning an existing task to the present project, searching the computing system 10 for existing tasks 500, and so forth.

While in the illustrated embodiment only the tasks 500 associated with a particular project are presented, the drop down menu 682 allows a user to filter the tasks presented on the visualization 400. For example, in response receiving a user selection of a task criteria in the drop down menu 682, the computing system 10 may cause certain tasks to be presented commensurate with the user selection of the task criteria from the drop down menu 682.

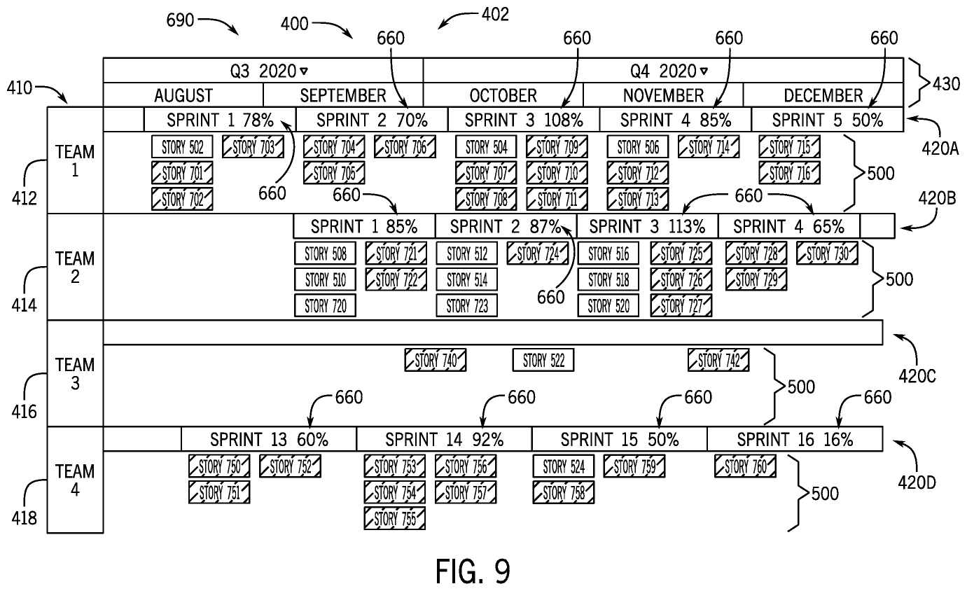

As one example, FIG. 9 is a screenshot 690 of the scrum program visualization 400 of FIG. 4 generated on the GUI 402 of FIG. 4, including additional tasks 500 assigned to the teams 410 of FIG. 5 in the sprints 420 of FIG. 7, in accordance with aspects of the present disclosure. For example, a user may make a selection on the drop down menu 682 indicative of displaying other tasks 500 beyond those assigned to a particular project. To help illustrate, the tasks 500 assigned to a first project are shown in white boxes, while the tasks assigned to other projects, such as a second project, are shown in striped boxes and are assigned reference numbers in the 700s. In this manner, the scrum program visualization 400 presented by the computing system 10 (FIG. 1) may include additional tasks beyond those that are assigned to a first project. That is, the computing system 10 may present tasks associated with other projects and update the bandwidths 660 based on those tasks.

In certain contexts, the computing system 10 may determine an authority level of a user. For users satisfying a threshold criteria of the authority level, the computing system 10 may allow those authenticated users to reassign tasks 500 as desired. For example, the third sprint (i.e., “Sprint 3”) 420A of the first team 412 includes a bandwidth 660 of 108%, indicating that the first team 412 has been assigned too much work for completion in the third sprint 420A. In this context, the authenticated user may drag and drop tasks 500, 700 away from the third sprint 420A to bring the bandwidth 660 at or under 100%.

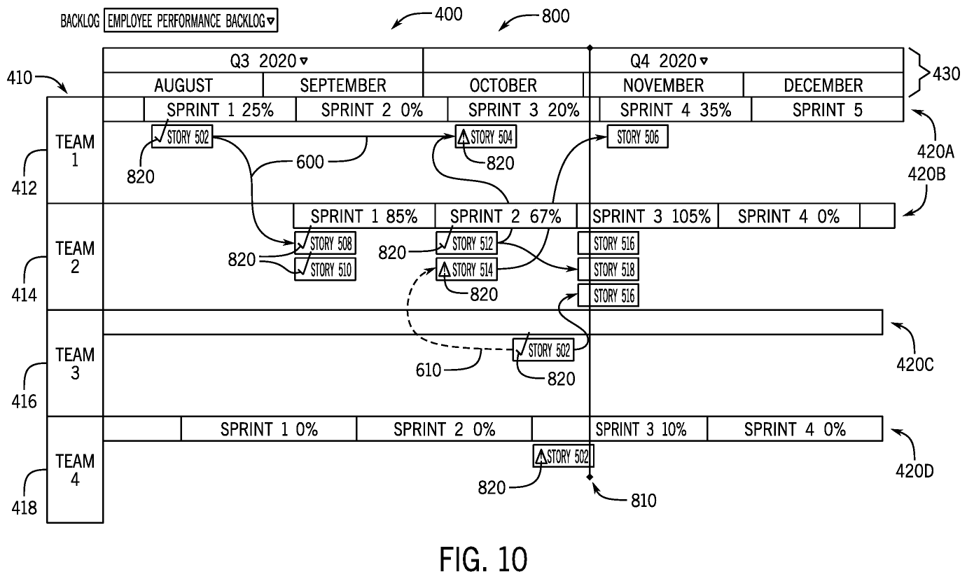

FIG. 10 is a screenshot 800 of the scrum program visualization 400 of FIG. 4, including a marker 810 indicative of the current date, in accordance with aspects of the present disclosure. The computing system 10 may present the marker 810 on the visualization 400 as a vertical line intersecting the timeline 430 at the current date. In this example, the current date is Oct. 31, 2020, such that the marker 810 intersects the timeline 430 at this date. The marker 810 may help orient a user in that it allows the user to see expired deadlines for tasks 500 and tasks 500 coming due. Furthermore, the computing system 10 may provide a status indicator 820 for all tasks having a deadline before the date associated with the marker 810, in this example, the check mark or the warning mark to indicate completion and incompletion, respectively. In this manner, a user may easily identify completion of tasks 500 and dependencies to adjust the project management plan if needed.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Technical effects of the present disclosure include improving operations for enterprises employing agile methodologies. Present embodiments include systems and methods for generating a visualization on a GUI, presenting a list of tasks associated with a project as assigned to various teams in their respective sprints. As mentioned above, systems and methods include generating the visualization based on team information, such as tasks and a timeframe (e.g., sprint) for completing the tasks, as well as dependencies between the tasks. To that end, present embodiments include presenting the visualization, such that the sprints between certain teams may be independent from one another. As a result, teams may have the flexibility to operate according to their own, independent timeframe because the start and end of one team's sprints may be independent and untethered to the start and end of another team's sprints. In this manner, project management may be improved by allowing teams to operate on their respective sprints, while allowing teams to identify dependencies between tasks to ensure prompt completion of an overall project. By improving the techniques used to plan projects and tasks, teams of varying sizes and resources may operate on their respective schedules and/or cycles, an enterprise may increase its efficiency, and projects may be completed in a timelier manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system to generate a graphical user interface (GUI) to facilitate project management, the system comprising:
a memory device; and
one or more hardware processors configured to read instructions from the memory device and execute the instructions to perform operations comprising:
receiving first team information associated with a first team and second team information associated with a second team, wherein the first team information comprises one or more first tasks for completion by the first team at a first time interval, wherein the second team information comprises one or more second tasks for completion by the second team at a second time interval, wherein the first time interval differs from the second time interval by at least one of:
a first start time of the first time interval being different than a second start time of the second time interval;
a duration of the first time interval being greater than a duration of the second time interval;
the duration of the first time interval being less than the duration of the second time interval; or
a first end time of the first time interval being different than a second end time of the second time interval;
determining a dependency between a particular first task of the one or more first tasks and a particular second task of the one or more second tasks based on the first team information and the second team information; and
generating a visualization, via the GUI, presenting a list of first tasks and a list of second tasks along a timeline with an indication for the dependency.

2. The system of claim 1, wherein the operations comprise:
determining that the dependency between the particular first task and the particular second task fails to match an arrangement of the particular first task and the particular second tasks along the timeline; and
generating a flagged indication as the indication for the dependency based on the determination that the dependency fails to match the arrangement, wherein the flagged indication visually differs from the indication for the dependency.

3. The system of claim 1, wherein the one or more first tasks and the one or more second tasks are part of a project, wherein the project comprises a plurality of tasks for completion by a plurality of teams.

4. The system of claim 1, wherein generating the visualization comprises generating a dependency indication between the particular first task of the one or more first tasks and the particular second task of the one or more second tasks.

5. The system of claim 4, wherein determining the dependency comprises determining that the particular first task is to be completed before a start of the particular second task based on the first team information and the second team information.

6. The system of claim 5, wherein generating the dependency indication comprises:
determining whether the particular first task is presented on the visualization, such that the particular first task is to be completed before the start of the particular second task; and
omitting a flagging indication associated with the dependency indication in response to determining that the particular first task is presented on the visualization such that the particular first task is to be completed before the start of the particular second task.

7. The system of claim 1, wherein the operations comprise:
receiving a change in duration of the first time interval, wherein the second time interval is unaffected by the change in the duration of the first time interval.

8. The system of claim 1, wherein the operations comprise:
generating a marker indicative of a current date on the visualization, wherein the marker comprises a vertical line intersecting the timeline at the current date, wherein tasks of the one or more first tasks and the one or more second tasks that antedate the current date comprise a status indicator, wherein the status indicator provides an indication of completion or an indication of incompletion.

9. The system of claim 1, wherein the project management is organized based on an agile development framework.

10. A method to use a graphical user interface (GUI) to facilitate project management, the method comprising:
receiving, via one or more processing devices, a first user input via the GUI requesting that a scrum board visualization be presented; and
in response to receiving the first user input, generating, via the one or more processing devices and on the GUI, the scrum board visualization presenting a list of first tasks assigned to a first team over a first time interval and a second list of second tasks assigned to a second team over a second time interval, wherein the first time interval differs from the second time interval by at least one of:
a first start time of the first time interval being different than a second start time of the second time interval;
a duration of the first time interval being greater than a duration of the second time interval;
the duration of the first time interval being less than the duration of the second time interval; or
a first end time of the first time interval being different than a second end time of the second time interval, or
wherein the scrum board visualization comprises a dependency visualization indicative of a dependency between a first particular task of the list of first tasks and a second particular task of the list of second tasks.

11. The method of claim 10, comprising:
determining, via the one or more processing devices, a dependency between the first particular task and the second particular task based on the list of first tasks, the list of first tasks, the first time interval, and the second time interval;
determining, via the one or more processing devices, an authority of the user;
determining, via the one or more processing devices, that the authority of the user satisfies a criteria; and
generating, via the one or more processing devices, one or more selectable features on the scrim board visualization for receiving second user inputs from the user to modify the dependency between the first particular task and the second particular task.

12. The method of claim 11, comprising: updating, via the one or more processing devices, the dependency indication based on receiving the second user inputs from the user to modify the dependency.

13. The method of claim 10, wherein each task of the list of first tasks and the list of second tasks are part of a project, wherein the project comprises a plurality of tasks for completion by a plurality of teams.

14. The method of claim 10, comprising, in response to receiving the first user input, determining, via the one or more processing devices, the dependency, wherein determining the dependency comprises determining that the first particular task is to be completed before the second particular task based on the list of first tasks, the list of second tasks, the first time interval, and the second time interval.

15. The method of claim 14, wherein generating the dependency indication comprises:
determining, via the one or more processing devices, whether the first particular task is presented on the scrum board visualization, such that the particular first task is to be completed before a start of the second particular task; and
omitting, via the one or more processing devices, a flagging indication associated with the dependency indication in response to determining that the particular first task is presented on the visualization such that the particular first task is to be completed before the start of the particular second task.

16. A non-transitory, computer readable medium comprising computer readable code, that when executed by one or more processors, causes the one or more processors to perform operations comprising:
receiving first team information associated with a first team and second team information associated with a second team, wherein the first team information comprises one or more first tasks for completion by the first team at a first time interval, wherein the second team information comprises one or more second tasks for completion by the second team at a second time interval, wherein the first time interval differs from the second time interval by at least one of:
a first start time of the first time interval being different than a second start time of the second time interval;
a duration of the first time interval being greater than a duration of the second time interval;
a duration of the first time interval being less than the duration of the second time interval; or
a first end time of the first time interval being different than a second end time of the second time interval;
determining a dependency between a particular first task of the one or more first tasks and a particular second task of the one or more second tasks based on the first team information and the second team information; and
generating a visualization, via a graphical user interface (GUI), presenting a list of first tasks and a list of second tasks along a timeline with an indication for the dependency.

17. The non-transitory, computer readable medium of claim 16, wherein the operations comprise:
determining that the dependency between the particular first task and the particular second task fails to match an arrangement of the particular first task and the particular second tasks along the timeline; and
generating a flagged indication as the indication for the dependency based on the determination that the dependency fails to match the arrangement, wherein the flagged indication visually differs from the indication for the dependency.

18. The non-transitory, computer readable medium of claim 16, wherein the one or more first tasks and the one or more second tasks are part of a project, wherein the project comprises a plurality of tasks for completion by a plurality of teams.

19. The non-transitory, computer readable medium of claim 16, wherein generating the visualization comprises generating a dependency indication between the particular first task of the one or more first tasks and the particular second task of the one or more second tasks.

20. The non-transitory, computer readable medium of claim 16, wherein the operations comprise:
generating a marker indicative of a current date on the visualization, wherein the marker comprises a vertical line intersecting the timeline at the current date, wherein tasks of the one or more first tasks and the one or more second tasks that antedate the current date comprise a status indicator, wherein the status indicator provides an indication of completion or an indication of incompletion.
